(19) United States
(12) Patent Application Publication
(10) Pub. No.: US 2012/0292925 A1
(43) Pub. Date: Nov. 22, 2012

(54) Electronic Unit For Locking Device And Locking System

(75) Inventors: Lars LUNDBERG, Stockholm (SE); Hakan NORDVALL, Eskilstuna (SE)

(73) Assignee: Dorma GmbH + Co. KG, Ennepetal (DE)

(21) Appl. No.: 13/475,519

(22) Filed: May 18, 2012

(30) Foreign Application Priority Data
May 19, 2011 (DE) 10 2011 050 495

(51) Int. Cl. E05C 1/06

(52) U.S. Cl. 292/144

(57) ABSTRACT

An electronic unit for adding to a manually operated locking device, in particular a mortise lock, to provide a manually and electronically operable locking system. The electronic unit includes a motor, gearing elements that can be operated by the motor the gearing elements configured to couple the motor to and to operate an opening and closing mechanism of the locking device connection elements for connecting the gearing elements of the electronic unit with the opening and closing mechanism and a control unit for operating the motor of the electronic unit. The gearing elements are built in such a way that during a manually operation of the locking system the motor is decoupled of the opening and closing mechanism.

### BACKGROUND OF THE INVENTION

1. Field of the Invention

The invention relates to an electronic unit for adding to a manually operated locking device, in particular a manually operated mortise lock. The invention further relates to a locking system being manually and electronically operable.

2. Description of the Related Art

Locking devices for movable elements like doors, windows, or the like are well known. Simple locking devices, in particular mortise locks, are often purely manually operable. Such locking devices have a latch bolt or a dead bolt, in particular a hook bolt that projects on the cuff plate side and which can be retracted by a latch mandrel-operated nut. The term “mortise lock” generally refers to locking devices that are designed to be inserted into a door, in particular into a space at the edge of a door. Mortise locks typically have one or more latches or bolts that project from the lock to engage with a strike or some other part of a door frame, window frame, or the like when the door, the window or the like is closed. The latches or bolts retain the door or window closed and have to be retracted back into the locking device to allow the door, the window or the like to be opened.

A wide range of different locking devices, in particular mortise locks, are used in the marketplace. Besides, purely manually locking devices motorised locking devices or electromechanical locking devices are known, as well, These locking devices are often operated by an electromagnet actuating a lever mounted on one side of the locking device and to which a rotationally mounted bolt is attached, too. When the electromagnet is energized, the lever is thereby held in its locked and unlocked position.

Purely manually operated locking devices are restricted in their operational field. Locking devices that can be operated manually and electromechanically are often very complex and expensive.

### SUMMARY OF THE INVENTION

It is an object of the present invention to provide an electronic unit that provides an easy and inexpensive way to enlarge a purely manually operable locking device, in particular a mortise lock, into a manually and electromechanically operable locking system. Further, a locking system is desired that can easily be changed between a purely manually operated locking device and a manually and electromechanically operated locking device.

According to a one embodiment of the present invention an electronic unit for adding to a manually operated locking device, in particular a mortise lock, provides a manually and electromechanically operable locking system. The electronic unit comprises a motor, gearing elements that can be operated by the motor, wherein the gearing elements are configured to couple the motor to and to operate an opening and closing mechanism of the locking device. Further, connection elements for connecting the gearing elements of the electronic unit with the opening and closing mechanism of the locking device and a control unit for operating the motor of the electronic unit are provided. The gearing elements of the electronic unit are built such that during a manually operation of the locking system the motor is decoupled of the opening and closing mechanism.

Such an electronic unit enables in an easy and cheap way to enlarge a purely manually operable locking device, in particular a mortise lock, into a manually and electromechanically operated locking system. An ordinary manually operated mechanical locking device can be enlarged by addition of the electronic unit to a manually and electromechanically operable locking system.

The electronic unit can be fixed to a standard manually operated locking device, in particular to a standard mortise lock. The electronic unit can be fixed to a manually operated locking device using simple connecting elements, like screws or the like. For example, a forend connecting screw and a barrel nut can be loosened and taken away. After that an upper or lower cover lid can be taken away from the locking device and the locking device body, respectively. The electronic unit can be inserted inside the locking device body at the same position as the cover lid was placed. After inserting the electronic unit into the locking device the forend connecting screw and the barrel nut can be reinstalled. In other words, the electronic unit can replace the upper or lower cover lid of a manually operated locking device. The addition of the electronic unit to the manually operated locking device provides a locking system that can be operated both manually and electromechanically.

The gearing elements of the electronic unit are operated by a motor or motor unit. The gearing elements are configured to couple the motor to an opening and closing mechanism of the locking device and to operate the opening and closing mechanism of the locking device. Therefore the gearing elements comprise a couple of gearing elements that interact with each other. The motor is able to move at least one of the gearing elements. This motor driven gearing elements transfers the movement to at least one further gearing element, which operates the opening and closing mechanism of the locking device. The connection elements of the electronic unit are configured in such a way that they connect the gearing elements of the electronic unit with the opening and closing mechanism of the locking device. In other words, the connection elements fix one of the gearing elements to the opening and closing mechanism of the locking device, so that a movement induced by the motor can be transferred to the opening and closing mechanism of the locking device. The motor of the electronic unit is operated by a control unit of the electronic unit. The control unit can be located inside the electronic unit, in particular inside a housing of the electronic unit. Alternative to that the control unit can be an external unit, which is placed separately to the electronic unit. The motor and the control unit, respectively, are being operated by a power supply. This power supply can be an electric current from a power grid or electric current out of a battery.

Advantageously, the gearing elements of the electronic unit are built such that during a manually operation of the locking system the motor is decoupled of the opening and closing mechanism. In other words, while manually operating the locking device the motor of the locking device is released from the gearing means and the gearing mechanism, respectively. That means, the motor of the electronic unit is not activated and effected by a manually use of the locking device. The motor of the locking device is not turned while turning the locking device, in particular the mortised lock, by a key or a thumb turn latch. Adding the electronic unit to a manually operated locking device enlarges the functionality of the locking device and the locking systems, respectively. In other words, adding the electronic unit to a manually operated locking device provides a locking system which can be operated both manually and electromechanically.

After inserting the electronic unit into the housing of a manually operated locking device and connecting the gearing elements of the electronic unit to the opening and closing mechanism of the manually operated locking device, a manifold locking system is created.

According to a preferred embodiment of the invention an electronic unit may be provided, wherein the gearing elements of the electronic unit comprise a first gearing element operable by the motor and a second gearing element connectable to the opening and closing mechanism, said gearing elements being configured such that they are coupleable at two coupling positions spaced apart by a predefined distance along in the relative movement of the first and second gearing elements. Such an electronic unit enables that during a manually operation of the locking system the motor is decoupled of the opening and closing mechanism. During an electromechanic operation of the electronic unit the motor moves the first gearing element. The first gearing element can be coupled at two coupling positions to the second gearing element. The first gearing element can be moved to the coupling positions by the motor. This can be done directly or indirectly. In other words, the first gearing element can be connected directly to the motor or indirectly to the motor. In the second case a further gearing element, like a rotor, can be arranged between the first gearing element and the second gearing element. When the first gearing element contacts the second gearing element at a first coupling position and is still moved by the motor, the second gearing element is moved in a first direction. When the first gearing element contacts the second gearing element at the second coupling position and is still moved by the motor, the second gearing element is moved in a second direction, in particularly opposite to the first direction. By moving the second gearing element the opening and closing mechanism of the locking device is moved, as well. Thereby a locking element of the locking system, like a dead bolt or latch, can be moved between a locking position and a non-locking position. The control unit enables that the locking and non-locking of the locking element of the locking system can be controlled without manually operating the locking device.

The gearing elements are being configured such that they are coupleable at two coupling positions. The two coupling positions are spaced apart by a predefined distance along in the relative movement of the first and second gearing elements. The predefined distance can be linear or arched, in particular circular.

The gearing elements of the electronic unit are built in such a way that if the first gearing element is not in contact with the second gearing element at a coupling position the locking system can be operated manually without activating and affecting the motor of the electronic unit. This can be done, because after the movement of the locking element is fulfilled the electronic unit stops the motor and the first gearing element is moved in a free position, where it has no contact to the second gearing element. In particular the first gearing element is moved in the proximity to the second coupling position. The predefined distance is equal or larger to the distance that the opening and closing mechanism of the locking device moves during the movement between the locking position and the non-locking position of the locking element. This enables that the first gearing element can be positioned by the motor such that it does not prevent the movement of the second gearing element and therefore the movement of the opening and closing mechanism of the locking device. During a manually operation of the locking system the motor is decoupled of the opening and closing mechanism. In other words, while manually operating the locking device the motor of the locking device is released from the second gearing element. That means, the motor of the electronic unit is not activated and affected by a manually use of the locking device. The motor of the locking device cannot be turned while turning the locking device, in particular the mortised lock, by a key or a thumb turn latch.

An electronic unit can be advantageous, by which the first gearing element of the electronic unit is moveable rotatably or linear relative to the second gearing element. The motor can cause a rotatably or linear movement of the first gearing element. The motor can be a linear motor. Alternative, the motor can be a rotating motor. If the motor is a linear motor, the first gearing element is moved along a linear direction. If the motor is a rotating motor, the first gearing element is moved in a circular direction.

According to a preferred further development of the invention an electronic unit may be provided, which is characterized in that the predefined distance is equal or greater than an operating distance of the opening and closing mechanism. This enables that the motor of the electronic unit is not activated and affected by a manually use of the locking device. The motor of the locking device is not turned while turning the locking device, in particular the mortised lock, by a key or a thumb turn latch. To realize this the motor transfers the first gearing element in such a position, that during a manually movement of the opening and closing mechanism the second gearing element does not come into contact with the first gearing element and thus does not activate the motor.

Adding the electronic unit to a manually operated locking device enlarges the functionality of the locking device and the locking system, respectively. In other words, adding the electronic unit to a manually operated locking device provides a locking system which can be operated both manually and electromechanically.

Further, an electronic unit is preferred, which is characterized in that the gearing elements comprise a rotor and an activation pin which is fixed at the rotor. The activation pin in particular is defining the first gearing element. The gearing elements further comprise a gear wheel, in particular defining the second gearing element, rotatably mounted at the rotor. The activation pin is being operable by the motor and the gear wheel is connectable to the opening and closing mechanism. Said activation pin and said gear wheel being configured in such a way that they are coupleable at two coupling positions being spaced apart by a predefined distance along in the relative movement of the activation pin and the gear wheel. The rotor can be driven by the motor of the electronic unit. The activation pin is fixed at the rotor. Advantageously, the activation pin is arranged perpendicular to the rotation axis of the rotor. The activation pin can be arranged radial to the rotor. The gear wheel is rotatably mounted at the rotor. The gear wheel stays in operational connection to the opening and closing mechanism. The activation pin can be moved between the two coupling positions. The coupling positions are defined as the positions where the activation pin contacts the gear wheel. In other words, the activation pin hits the gear wheel at two points. That means when the activation pin hits the gear wheel at a first coupling position and is still moved by the motor, the gear wheel is moved in a first direction. Thereby the gear wheel moves the opening and closing mechanism of the locking device into a first direction. When the activation pin hits the gear wheel at the second coupling position and is still moved by the motor, the gear wheel is moved in a second direction, in particularly opposite to the first direction. By moving the gear wheel the opening and closing mechanism of the locking device is moved, as well. A movement of the opening and closing mechanism of the locking system causes a movement of a locking element, like a bolt or latch, between a locking position and a non-locking position.

After the movement of the locking element into a locking position is fulfilled the control unit stops the motor and the activation pin is moved in a free position where it has no contact to the second gearing element. In particular the first gearing element is moved in the proximity to the second coupling position. The predefined distance is equal or larger to the distance which the opening and closing mechanism of the locking device moves during the movement between the locking position and the non-locking position of the locking element. This enables that the first gearing element can be positioned by the motor such that it does not prevent the movement of the second gearing element and therefore the movement of the opening and closing mechanism of the locking device. During a manually operation of the locking system the motor is decoupled of the opening and closing mechanism. In other words, while manually operating the locking device the motor of the locking device is released from the second gearing element. That means, the motor of the electronic unit is not activated and affected by a manually use of the locking device. The motor of the locking device cannot be turned while turning the locking device, in particular the mortised lock, by a key or a thumb turn latch. Thus, the motor cannot stop the movement of the locking device when the locking system is operated manually.

As already stated, it could also be of advantage, if an electronic unit is characterized in that the gearing elements are configured such that they transfer a linear movement or a rotational movement of the motor into a linear movement of the connection elements.

According to one preferred embodiment of the present invention the gearing elements of an electronic unit comprise a gear bar which is operatively connected to the gear wheel, wherein the connection means are fixed to said gear bar. That means the gear bar is in conjunction with the gear wheel on one side and in conjunction with the opening and closing mechanism on the other side. The connections elements for fixing the gearing elements to the opening and closing mechanism are advantageously arranged at the gear bar. Thus, a movement of the gear bar initiated by the motor can be directly transferred to the opening and closing mechanism, in particular a gear bar or rack, of the locking device.

A preferred electronic unit is characterized in that the gearing elements comprise at least two gearing elements and the control unit is configured such that it operates the motor to move at least one gearing element, in particular the first gearing element, in a neutral position to decouple the motor from the opening and closing mechanism. That means the control unit is configured such that it can control the motor to bring the first gearing element, in particular the activating pin, in a mechanical free or unaffected position. In this position a movement of the second gearing element, in particular the gear wheel is free. That means, while the opening and closing mechanism and therefore the second gearing element is moved manually the first gearing element is positioned in such a place, where it does not get into contact to the second gearing element. Only by operating the first gearing element by the motor and a movement of the first gearing element in direction to one of the coupling positions the first gearing element can influence the movement of the locking element of the locking system again.

According to one embodiment of the present invention, the electronic unit is characterized in that a sensor unit is provided for sensing the operation of the opening and closing mechanism to enable the control unit to decouple the motor from the opening and closing mechanism after said operation is finished. The sensor unit comprises one or more sensor elements. The sensor unit senses the operation of the opening and closing mechanism or of the locking element. Therefore, the sensor unit is able to enable the control unit to decouple the motor from the opening and closing mechanism after said operation is finished. In other words, if the sensor detects that the opening and closing mechanism and therefore the locking element, in particular a bolt or latch, of the locking system has reached the locking position, a signal is given to the control unit, so that the control unit can control the motor to decouple the first gearing element, in particular the activating pin, and thereby the motor from the second gearing element, in particular the gear wheel, and from the opening and closing mechanism. This enables that a manually operation of the opening and closing mechanism of the locking system has no influence and affect to the motor of the electronic unit. But on the other hand the opening and closing mechanism can be driven by the electronic unit, if desired.

In one embodiment the electronic unit is characterized in that the connection elements are configured to provide form- and/or friction locking between the gearing elements and the opening and closing mechanism. Advantageously, the connection elements of an inventive electronic unit are latching elements, in particular a connecting spring. This enables to establish an easy fixation between the gearing elements of the electronic unit and the opening and closing mechanism of the locking device after fixation, in particular insertion, of the electronic unit at or in the locking device. Through adding the electronic to the locking device a locking system is provided that can be operated in both ways, manually and electromechanically.

It could be of advantage, when an electronic system according to the present invention is characterized in that the control unit is connected to a power supply. The power supply can be a power grid or a battery. The activation of the motor by the control unit can be done with wired transmission or wirelessly.

A further aspect of the present invention is a locking system comprising a manually operated locking device and an electronic unit with the features according to the first aspect of the invention. Such a locking system makes use of the same advantages already described above with respect to the inventive electronic unit.

Further, a locking system is preferred, wherein the locking system is characterized in that a locking element is provided to be selectively operable by the manually operated locking device or the electronic unit. That means, if necessary the locking system can be operated manually by a key or a pawl, in particular a handle, like a door handle, or the locking system can be operated electromechanically by the control unit of an electronic unit. The operation through the electronic unit has the advantage that the locking system can be remote-controlled. In particular, the locking or non-locking of the locking system can be controlled at predefined times.

A locking system can comprise one or more locking elements, like dead bolts, hook bolts, or latch bolts. Further, a locking device can have two or more gearing elements and two or more opening and closing mechanisms. The two or more gearing elements can be driven by one or more motors. The locking system can be any type of a locking system. Advantageously, the locking system is a mortise lock. The mortise lock can be arranged in a door, a window or the like.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is further described with respect to the accompanying drawings. In the drawings:

FIG. 1 is a sectional view of an upper part of a locking system, wherein the locking element of the locking system is in the locking position;

FIG. 2 are the gearing elements of the electronic unit of the locking system according to FIG. 1;

FIG. 3 is a sectional view of the upper part of the locking system according to FIG. 1, wherein the locking element of the locking system is in the non-locking position;

FIG. 4 are the gearing elements of the electronic unit of the locking system according to FIG. 1;

FIG. 5-10 are different positions of gearing elements of gearing elements of an electronic unit of a locking system;

FIG. 11 is an electronic unit;

FIG. 12-13 is the electronic unit according to FIG. 11 inserted into a locking device to build a locking system;

FIG. 14-15 are side views of a locking system;

FIG. 16 is a part of the gearing elements of the electronic unit at the beginning of the fixation to the opening and closing mechanism of a locking device;

FIG. 17 is the part of the gearing elements of the electronic unit according to FIG. 16 during the fixation to the opening and closing mechanism of a locking device;

and

FIG. 18 is an enlarged presentation of a part a gearing elements of an electronic unit.

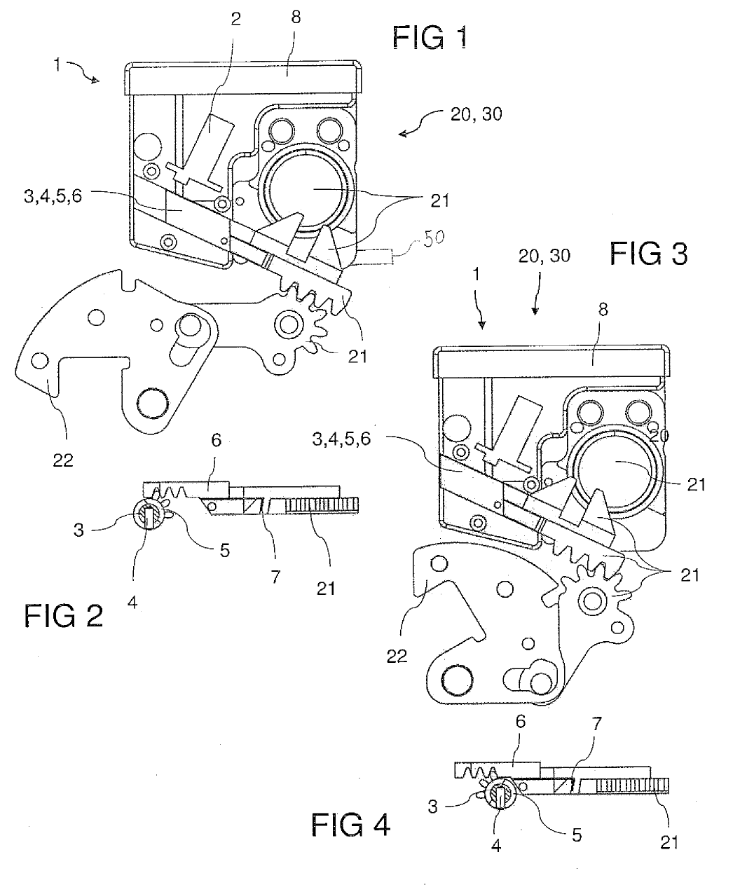

Elements with the same function and mode of operation are provided with the same reference numbers in the FIGS. 1 to 18.

### DETAILED DESCRIPTION OF THE PRESENTLY PREFERRED EMBODIMENTS

FIG. 1 shows a sectional view of an upper part of a locking system 30, constructed according to one inventive construction principle, wherein the locking element 22 of the locking system 30 is in the locking position. The electronic unit 1 is arranged next to the opening and closing mechanism 21 of the locking device 20. The electronic unit 1 is added to the manually operable locking device 20 to build a manifold locking system 30. Therefore the electronic unit 1 is fixed to the manually operable locking device 20. In particular the electronic unit 1 can be inserted into the upper part of the manually operable locking device 20. To operationally couple the electronic unit 1 with the manually operable locking device 20 the gearing elements 3, 4, 5, 6 of the electronic unit 1 are connected to the opening and closing mechanism 21 of the locking device 20. The connection is been made by connection element 7 fixed at one gearing element 6 of the gearing elements 3, 4, 5, 6, see FIG. 2. The connection element 7 is a spring element, which interlocks with the opening and closing mechanism 21 of the locking device 20. The opening and closing mechanism 21 comprises a couple of gearing element. The opening and closing mechanism 21 is connected to the locking element 22, here in form of a hook bolt. Through a movement of the opening and closing mechanism 21 the locking element 22 can be brought into a locking position, shown in FIG. 1, and into a non-locking position, shown in FIG. 3. In the locking position of the locking element 22 according to FIG. 1 the gearing elements 3, 4, 5, 6 are arranged in a different way relative to each other, than in a non-locking position as shown in FIGS. 2 and 4.

The electronic unit 1 is built for adding to a manually operated locking device 20, in particular a mortise lock, to provide a manually and electronically operable locking system 30. The electronic unit 1 comprises a motor 2 and gearing means 3, 4, 5, 6 that can be operated by the motor 2. The gearing means 3, 4, 5, 6 are configured to couple the motor 2 to and to operate an opening and closing mechanism 21 of the locking device 20. The connection element 7 is necessary for connecting the gearing elements 3, 4, 5, 6 of the electronic unit 1 with the opening and closing mechanism 21. Further, a control unit 8 is provided for operating the motor 2 of the electronic unit 1. The control unit 8 can be arranged inside the electronic unit 1, in particular inside a housing of the electronic unit 1, or can be arranged outside the electronic unit 1. The gearing element 3, 4, 5, 6 are built such that during a manually operation of the locking system 30 the motor 2 is decoupled of the opening and closing mechanism 21.

Such an electronic unit 1 enables in an easy and cheap way to enlarge a purely manually operable locking device 20, in particular a mortise lock, into a manually and electromechanically operated locking system 30. That means, a manually operated locking device 20 can be enlarged by addition of the electronic unit 1 to a manually and electromechanically operable locking system 30.

The gearing elements 3, 4, 5, 6 of the electronic unit 1 are built such that if the first gearing element 4, which is preferably an activating pin, is not in contact with the second gearing element, which is preferably a gear wheel, at a coupling position, the locking system 30 can be operated manually without activating and affecting the motor 2 of the electronic unit 1. The gearing elements 3, 4, 5, 6 are being configured such that they are coupleable at two coupling positions. The two coupling positions are being spaced apart by a predefined distance 9 along in the relative movement of the first and second gearing elements 4, 5. The predefined distance can be linear or circular.

The gearing elements 3, 4, 5, 6 of the electronic unit 1 are operated by a motor 2 or motor unit. The gearing elements 3, 4, 5, 6 are configured to couple the motor 2 to an opening and closing mechanism 21 of the locking device 20 and to operate the opening and closing mechanism 21 of the locking device 20. Therefore, the gearing elements 3, 4, 5, 6 comprise a couple of gearing elements that interact with each other. The motor 2 is able to move at least one of the gearing elements 4. This motor driven gearing element 4 transfers the movement to at least one further gearing element 5, which operates the opening and closing mechanism 21 of the locking device 20. The connection elements 7 fixes the at least one gearing element 6 to the opening and closing mechanism 21 of the locking device 20, so that a movement induced by the motor 2 can be transferred to the opening and closing mechanism 21 of the locking device 20. The motor 2 of the electronic unit 1 is operated by the control unit 8 of the electronic unit 1.

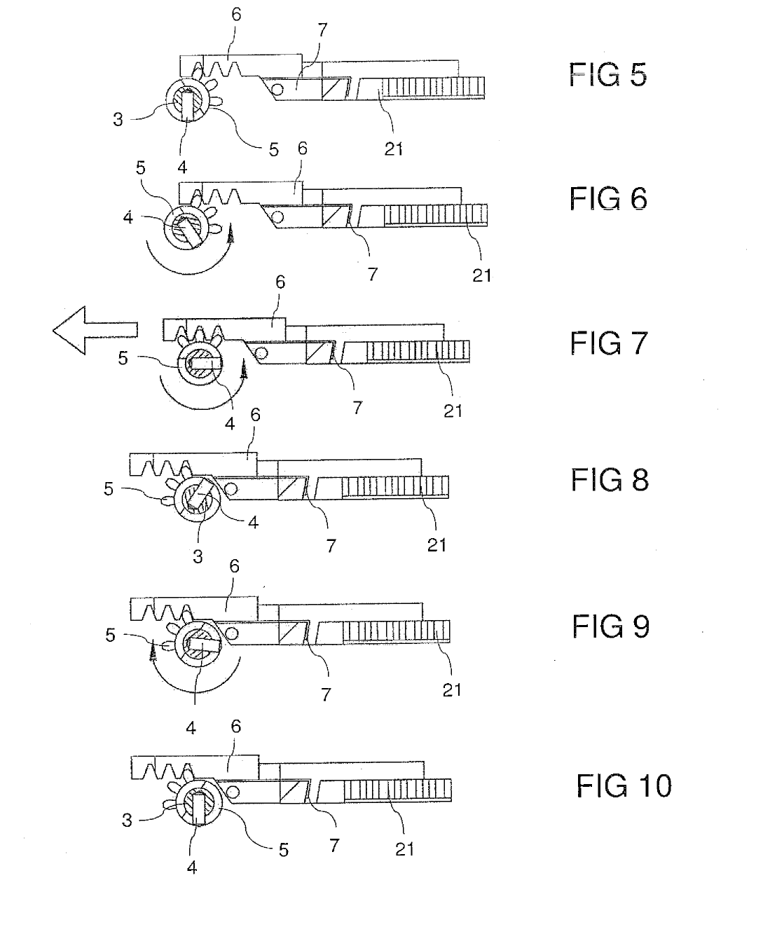

The different positions of the gearing elements 3, 4, 5, 6 of the gearing elements of an electronic unit 1 relative to each other are disclosed in FIGS. 5 to 10. The gearing elements 3, 4, 5, 6 of the electronic unit 1 comprise a rotor 3 and an activation pin 4 which is fixed at the rotor 3. The activation pin 4 is defining the first gearing element. The gearing elements 3, 4, 5, 6 further comprise a gear wheel 5, in particular defining the second gearing element, rotatably mounted at the rotor 3. The activation pin 4 is being operable by the motor 2 and the gear wheel 5 is being connectable to the opening and closing mechanism 21 of the locking device 20. The activation pin 4 and the gear wheel 5 are being configured such that they are coupleable at two coupling positions being spaced apart by a predefined distance 9 along in the relative movement of the activation pin 4 and the gear wheel 5 as shown in FIG. 18. The rotor 3 can be driven by the motor 2 of the electronic unit 1. The activation pin 4 is fixed at the rotor 2. In particular, the activation pin 4 is arranged perpendicular to the rotation axis of the rotor 2. The gear wheel 5 is rotatably mounted at the rotor 3. The gear wheel 5 stays in operational connection to the opening and closing mechanism 21. The activation pin 4 can be rotatably moved by the rotor 3. The activation pin 4 can be moved free between the two coupling positions. The coupling positions are defined as the positions where the activation pin 4 contacts the gear wheel 5. In other words, the activation pin 4 can hit the gear wheel 5 at two points. When the activation pin 4 hits the gear wheel 5 at a first coupling position and is still moved by the motor 2, the gear wheel 5 is moved in a first direction. In FIG. 5 the activation pin 4 stays not in contact to the gear wheel 5. In FIG. 6 the activation pin 4 is further rotated and hits the gear wheel 5 at a first coupling position. If the activation pin 4 is still moved the gear wheel 5 moves the gear bar 6 and thereby the opening and closing mechanism 21 of the locking device 20 as shown in FIG. 7. In FIG. 8 the movement of the opening and closing mechanism 21 of the locking device 20 and therefore the movement of the locking element 22 of the locking device 20 are fulfilled.

A sensor unit 50, is provided for sensing the operation of the opening and closing mechanism 21 or the movement of the locking element 22 to enable the control unit 8 to decouple the motor 2 from the opening and closing mechanism 21 after said operation is finished, in other words after the movement of the locking element 22 of the locking device 20 is fulfilled. The sensor unit 50 detects that the opening and closing mechanism 21 and therefore the locking element 22, in particular a hook bolt or latch, of the locking system 30 has reached the locking position. After that, the sensor unit sends a signal to the control unit 8, so that the control unit 8 can control the motor 2 to decouple the activating pin 4 and the motor 2 from the gear wheel 5 and thereby from the opening and closing mechanism 21 as shown in FIGS. 9 and 10. This enables that a manually operation of the opening and closing mechanism 21 of the locking system 30 has no influence and affect to the motor 2 of the electronic unit 1.

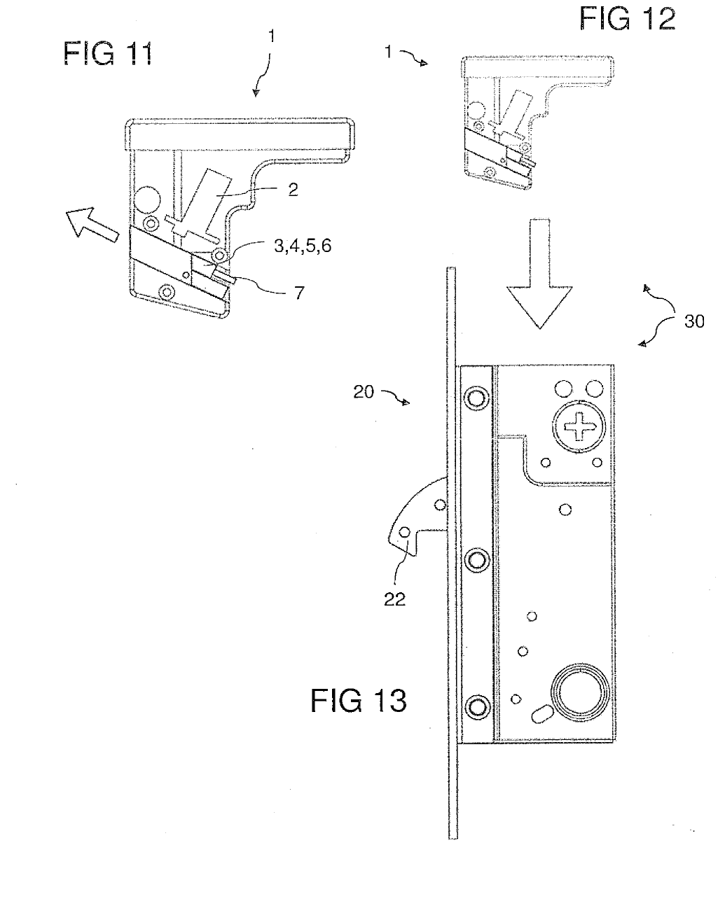

FIG. 11 shows schematically an electronic unit 1 constructed according to the inventive construction principle. In FIGS. 12 and 13 the electronic unit according to FIG. 11 is inserted into a locking device 20 to build a locking system 30.

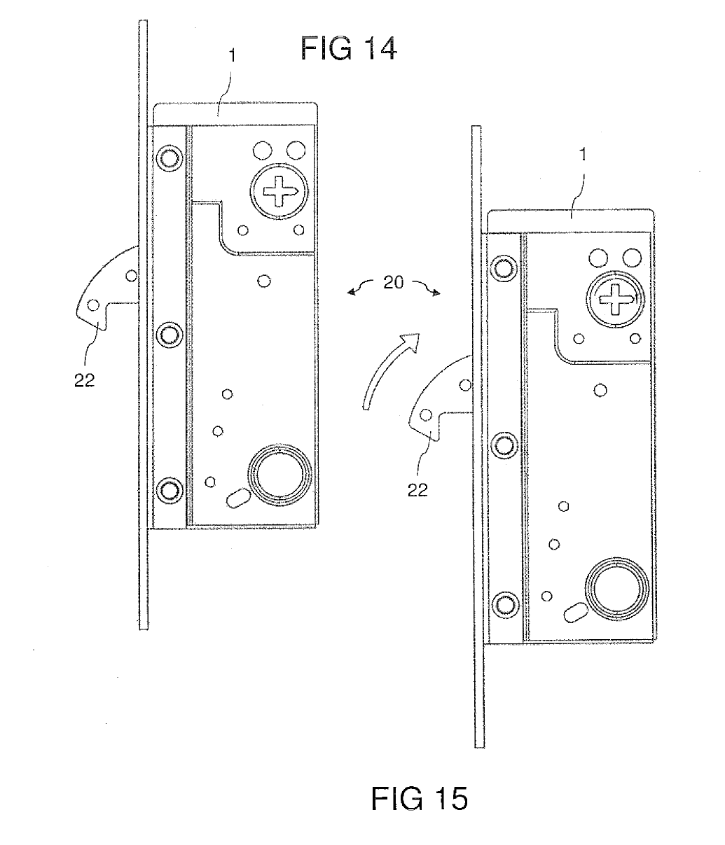

FIG. 14-15 show schematically side views of an inventive locking system 30.

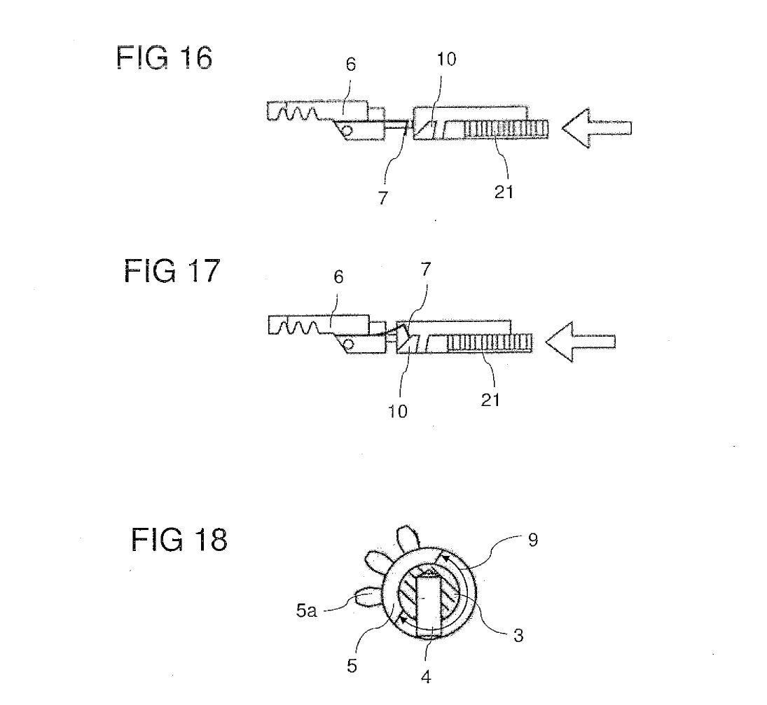

In FIG. 16 the gear bar 6 of the gearing elements of the electronic unit 1 is shown at the beginning of the fixation to the opening and closing mechanism 21 of a locking device 20. FIG. 17 discloses the gear bar 6 of the gearing elements of the electronic unit 1 according the FIG. 16 during of the fixation to the opening and closing mechanism 21 of a locking device 20. At the gear bar 6 of the gearing elements the connection elements 7, here in form of a latching element, are arranged. The latching element 7 slides on a counter-latching element 10 of the opening and closing mechanism 21 and is thereby pushed back by the counter-latching element 10. At the end of the fixation the latching element 7 snaps behind the counter-latching element 10 to fix the gear bar 6 of the gearing elements to the opening and closing mechanism 21.

FIG. 18 shows schematically an enlarged presentation of some gearing elements 3, 4, 5 of the gearing elements of an electronic unit 1. Further, in FIG. 18 the defined distance 9 is shown which the activating pin 4 has to cover between the two coupling positions, The coupling positions are the places where the activating pin 4 hits against the gear wheel 5. The defined distance 9 is equal or larger than the distance that the opening and closing mechanism 21 has to cover when moving between its two end positions.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An electronic unit for adding to a manually operated locking device configured as a mortise lock to provide a manually and electronically operable locking system, the electronic unit comprising:
an opening and closing mechanism of the locking device;
a motor;
gearing elements that are operated by the motor, the gearing elements configured to couple the motor to and to operate the opening and closing mechanism of the locking device;
connection elements for connecting the gearing elements with the opening and closing mechanism; and
a control unit for operating the motor,
wherein the gearing elements decouple the opening and closing mechanism from the motor during a manually operation of the locking system.

2. The electronic unit according to claim 1, wherein the gearing elements comprise a first gearing element operable by the motor and a second gearing element connectable to the opening and closing mechanism, said gearing elements configured such that they are coupled at two coupling positions that are spaced apart by a predefined distance along in a relative movement of the first and second gearing elements.

3. The electronic unit according to claim 2, wherein the first gearing element is moveable at least one of rotatably and linear relative to the second gearing element.

4. The electronic unit according to claim 2, wherein the predefined distance is equal or greater than an operating distance of the opening and closing mechanism predefined distance.

5. The electronic unit according to claim 2, wherein the gearing elements comprise:
a rotor;
an activation pin fixed at the rotor, the activation pin defining the first gearing element;
a gear wheel rotatably mounted at the rotor defining the second gearing element;
wherein the activation pin is operable by the motor and the gear wheel is connectable to the opening and closing mechanism, said activation pin and said gear wheel configured such that they are coupled at two coupling positions that are spaced apart by a predefined distance along in the relative movement of the activation pin and the gear wheel.

6. The electronic unit according to claim 1, wherein the gearing elements are configured in such a way that they transfer one of a linear movement and a rotational movement of the motor into a linear movement of the connection elements.

7. The electronic unit according to claim 5, wherein the gearing elements comprise a gear bar that is operatively connected to the gear wheel, the connection elements being fixed to said gear bar.

8. The electronic unit according to claim 1, wherein the gearing elements comprise at least two gearing elements and the control unit is configured such that it operates the motor to move the first gearing element in a neutral position to decouple the motor from the opening and closing mechanism.

9. The electronic unit according to claim 1, wherein a sensor unit is provided for sensing the opening and closing mechanism to enable the control unit to decouple the motor from the opening and closing mechanism after its operation is finished.

10. The electronic unit according to claim 1, wherein the connection elements are configured to provide at least one of form and friction locking between the gearing elements and the opening and closing mechanism.

11. The electronic unit according to claim 1, wherein the connection elements are latching elements.

12. The electronic unit according to claim 1, wherein the control unit is connected to a power supply.

13. A locking system comprising:
a manually operated locking device; and
an electronic unit comprising:
an opening and closing mechanism of the locking device;
a motor;
gearing elements that are operated by the motor, the gearing elements configured to couple the motor to and to operate the opening and closing mechanism of the locking device;
connection elements for connecting the gearing elements with the opening and closing mechanism; and
a control unit for operating the motor,
wherein the gearing elements decouple the opening and closing mechanism from the motor during a manually operation of the locking system.

14. The locking system according to claim 13, wherein, a locking element is provided to be selectively operable by at least one of the manually operated locking device and the electronic unit.

15. The locking system according to claim 13, wherein the locking system is a mortise lock.

16. The electronic unit according to claim 11, wherein the latching elements are configured as a connecting spring.
